(19) United States
(12) Patent Application Publication
(10) Pub. No.: US 2006/0200403 A1
(43) Pub. Date: Sep. 7, 2006

(54) Method and apparatus for distributing items

(76) Inventor: Warren E. Friss, Westfield, NJ (US)

Correspondence Address: PATENT DOCKET CLERK;COWAN, LIEBOWITZ & LATMAN, P.C., 1133 AVENUE OF THE AMERICAS, NEW YORK, NY, 10036, US

(21) Appl. No.: 11/365,418

(22) Filed: Mar. 1, 2006

Related U.S. Application Data
(60) Provisional application No. 60/657,336, filed on Mar. 1, 2005.

(51) Int. Cl. G06Q 30/00; G06Q 40/00

(52) U.S. Cl. 705/37; 705/26

(57) ABSTRACT

A method is disclosed for managing the trade of at least one offered item by at least one item offeror for at least one wanted item of at least one item acceptor. First, the method of managing item trades includes the step of establishing for the one item acceptor and the one item offerer a database for storing information identifying each item held respectively by the one item offerer and the one item acceptor. Next, the item acceptor is facilitated to provide an acceptance message of trading the offered item of the item offerer for the wanted item of the item acceptor. The method responds to the acceptance message to access the database of the item acceptor to determine whether the item acceptor has the wanted item in its database and to access the database of the item offerer to determine whether the item offerer has the offered item in its database. If the item acceptor and the item offerer have respectfully their wanted item and their offered item, then the trade may continue to completion, i.e., the item offerer receives the wanted item and the item acceptor receives the offered item.

### RELATED PATENT APPLICATION

This application relates to U.S. Non-Provisional patent application Ser. No. 09/488,107 entitled “METHOD AND APPARATUS FOR OFFERING FOR SALE COLLECTIBLES ON PRIMARY AND SECONDARY MARKETS” and to U.S. Provisional Application Ser. No. 60/657,336 entitled “METHOD AND APPARATUS FOR DISTRIBUTING ITEMS”, which are incorporated herein by reference.

### FIELD OF THE INVENTION

This invention relates to the distribution of items by trading a first set of one or more items for a second set of one or more items. In an illustrious embodiment of this invention, the items may take the form of trading cards and, in particular, those cards bearing the images of athletes. Further, the items may also include other kinds of collectibles and may include the exchange or trading of different kinds of items. This invention also relates to the trading of one item for another, as opposed to purchasing an item for a set amount of money.

### BACKGROUND OF THE INVENTION

The Internet comprises a vast number of computers and computer networks that are interconnected through communication links. The interconnected computers exchange information using various services, such as electronic mail, Gopher, and the World Wide Web (“WWW”). The WWW service allows a server computer system (i.e., Web server or Web site) to send graphical Web pages of information to a remote computer system. The remote computer system can then display the Web pages. Each resource (e.g., computer or Web page) of the WWW is uniquely identifiable by a Uniform Resource Locator (“URL”). To view a specific Web page, a item distribution computer system specifies the URL for that Web page in a request (e.g., a HyperText Transfer Protocol (“HTTP”) request). The request is forwarded to the Web server that supports that Web page. When the Web server receives the request, it sends that Web page to the computer system. When the computer system receives that Web page, it typically displays the Web page using a browser. A browser is a special-purpose application program that effects the requesting of Web pages and the displaying of Web pages.

Currently, Web pages are typically defined using HyperText Markup Language (“HTML”). HTML provides a standard set of tags that define how a Web page is to be displayed. When a user indicates to the browser to display a Web page, the browser sends a request to the server computer system to transfer to the computer system an HTML document that defines the Web page. When the requested HTML document is received by the computer system, the browser displays the Web page as defined by the HTML document. The HTML document contains various tags that control the displaying of text, graphics, controls, and other features. The HTML document may contain URLs of other Web pages available on that server computer system or other server computer systems.

The World Wide Web is especially conducive to conducting electronic commerce. Web Servers have been programmed to permit vendors to provide a wide array of products and services for sale over the Internet. A user, who is a potential item distributor, purchaser or trader, may browse one or more web sites, which provide lists of products or services for sale, much like a catalogue. A user may preview these lists to select a desired product or services to be purchased. When the user has completed selecting the items to be purchased, the server computer system then prompts the user to enter information to complete the ordering of the selected items. This system generally determines how and where the selected items may be delivered to the item distribution and how the user will pay for the selected items.

There are dozens of different buyer-seller protocols in use today. However, almost all of those systems are seller-driven in the sense that they focus on the methods and processes available to the seller, allowing him/her to price, package or configure goods and services more effectively. Stores, catalogs, classified advertisements, telemarketing, offering for sale houses, even on-line computerized reservation systems such as SABRE, are all seller-driven. Traditionally, it is the seller's job to attract buyers and then to complete the sale. Thus, in a seller-driven system, the advertising cost of the transaction and the attendant risks that such advertising will be unsuccessful falls upon the seller.

Most goods and services purchased at retail are done so using a general seller-driven protocol whereby the seller sets a price and the buyer decides whether or not to accept that price. Prices for some services, such as airline tickets, might change frequently, but the buyer must still wait for the seller to offer a price he finds acceptable. Obviously, some forms of commerce offer far more give and take with offers and counteroffers being exchanged, however the vast majority of retail purchases utilize seller-driven, fixed-price, non-negotiable pricing protocols.

Auctions are probably the most frequently used system whereby prices are not fixed by the seller. Here too, the system is seller-driven. The buyer does not find the seller, rather the seller attracts numerous buyers who, as a group, determine the final selling price—which the seller may subsequently reject unless the item offered for sale is being purchased without a reserve.

Even on-line reservation systems are seller-driven. Airline reservation systems such as SABRE are in the business of constantly posting airfares. Travel agents and consumers are on the order for side of the process. However, since they cannot communicate their orders to the airlines, they must wait until an “asked” fare is quoted which meets their needs.

Other commerce systems are exchange-driven. These systems, such as NASDAQ or the New York Stock Exchange (NYSE), match buyers and sellers by offering an efficient, fair and orderly marketplace. They favor neither buyers nor sellers, but simply effectuate communications that allow for the matching process to take place. An example of an automated exchange-driven commerce system for trading futures is disclosed in U.S. Pat. No. 4,903,201.

U.S. Non-Provisional application Ser. No. 09/488,107 contemplates that collectibles and, in particular, the athlete trading cards may be exchanged over the Internet. For example, if you believe that Derek Jeter will become the best shortstop of all time, then the user would want to obtain a number of his cards. Presently, athletic trading cards are purchased on the primary market in packs. A pack includes a number of cards, each of which is different from the others. Each pack is typically wrapped so that the item distribution can not tell what cards are in a particular pack. If the potential purchaser would seek to obtain a number of Derek Jeter cards, he/she would need to purchase a number of packs and, even then, would not be assured of finding any Derek Jeter cards. The item distribution could also go to a secondary market and start buying Derek Jeter cards. Even in the secondary market, e.g., stores or web sites that specialize in the sale of trading cards, the investor is only likely to secure one Derek Jeter card at a time. In accordance with this invention, lots of single desired cards will be efficiently offered for sale to the item distribution.

Even if alternative mediums exist to purchase lots of trading cards at one time at prices that are not seller driven, the cards are then usually immediately physically delivered to the purchaser. For users to then trade or sell them to other users via electronic mediums, they face barriers of trust as to whether they really own them and whether the condition is as advertised. Moreover, no forum exists to trade their trading cards for other different collectibles or items, such as coins. This Non-Provisional patent application, Ser. No. 09/488,107 contemplates that manufacturers/issuers (or administrators whom they have partnered with) (i) retaining trading cards or other collectibles they sell in personal accounts they maintain for their customers, while reserving their condition (ii) hosting an online trading platform in which customers can post and execute possible trades of items and collectibles (even of a different type) held by the manufacturers/issuers/administrators (knowing their condition and existence is guaranteed) and (iii) transferring the traded items/collectibles to the respective traders' accounts.

This invention differs from those trading systems described above, wherein one or more collectibles are sold for a set amount of money. In contrast, this invention relates to trading one item for another. Though not limited to the disclosed embodiments of this application, the traded items can take the form of trading cards and, in particular, athlete trading cards. A significant problem that occurs when one item is traded for the other, is that one or more of the parties to the transaction may not actually have the item that is to be traded. The invention described below in one aspect thereof is able to check whether or not the participants in such a trade actually have the item sought to be traded.

### SUMMARY OF THE INVENTION

In accordance with the above and other objects of this invention, there is disclosed a method for managing the trade of at least one offered item by at least one item offeror for at least one wanted item of at least one item acceptor. First, the method of managing item trades includes the step of establishing for the one item acceptor and the one item offerer a database for storing information identifying each item held respectively by the one item offerer and the one item acceptor. Next, the item acceptor is facilitated to provide an acceptance message of trading the offered item of the item offerer for the wanted item of the item acceptor. The method responds to the acceptance message to access the database of the item acceptor to determine whether the item acceptor has the wanted item in its database and to access the database of the item offerer to determine whether the item offerer has the offered item in its database. If the item acceptor and the item offerer have respectfully their wanted item and their offered item, then the trade may continue to completion, i.e., the item offerer receives the wanted item and the item acceptor receives the offered item.

### BRIEF DESCRIPTION OF THE DRAWINGS

The forgoing objects and advantages of the present invention may be more readily understood by one skilled in the art with reference being had to the following detailed description of a preferred embodiment thereof, taken in conjunction with the accompanying drawings wherein like elements are designated by identical reference numerals throughout the several views, and in which:

FIG. 1 is a functional block diagram illustrating how a plurality of user terminals and a server system for a web site to be accessed are connected to and by a communication link to each other;

FIGS. 2A and 2B illustrate a plurality of screens or webpages that are downloaded from the server system to appear on a display of the user terminals to variously present the items or collectibles that are being offered for sale or exchange;

FIG. 3 is a flow diagram of a program, which is loaded on the server system to permit an offering for an administrator to build an Initial Player Offering, whereby a plurality of selected collectibles may be offered for sale;

FIG. 4 is a flow diagram of a program, which is loaded on the server system, to run an offering for sale, whereby a plurality of the users can transmit from each of their systems orders to the server system and the placed orders processed to determine the successful purchaser(s);

FIG. 5 is a flow diagram of a program, which is loaded on the server system, to control the construction of an item distribution's history database at the server system, whereby a record of the orders made in the course of one or more offerings or transactions and the items so purchased is built;

FIG. 6 is a more detailed flow diagram than that of FIG. 5 of a program, which is executed on the server system to tally the number of orders for each of the items offered for exchange and to determine the successfully distributed items;

FIG. 7 is a high level flow diagram showing the trade of offered cards or items by an item offerer for a wanted card or item for an item acceptor;

FIG. 8 is a more detailed flow diagram of how the item offerer constructs a trade offer comprised of a wanted item and one or more offered items;

FIGS. 9A and B are respectively screens or webpages that are downloaded from the server system shown in FIG. 1 to respectively display the wanted item and the offered items and for facilitating the item offerer to add or remove one of the offered items from the proposed trade;

FIG. 10 is a more detailed flow diagram for illustrating the process of enabling the item acceptor to transfer its owned card and to accept the offered cards therefore; and

FIGS. 11A and B are respectively a screen bearing a listing of the items wanted by the item offerer, and a screen displaying the item wanted by the item offerer and a button to be activated by the item acceptor to accept the trade.

### DETAILED DESCRIPTION OF A PREFERRED EMBODIMENT OF THE INVENTION

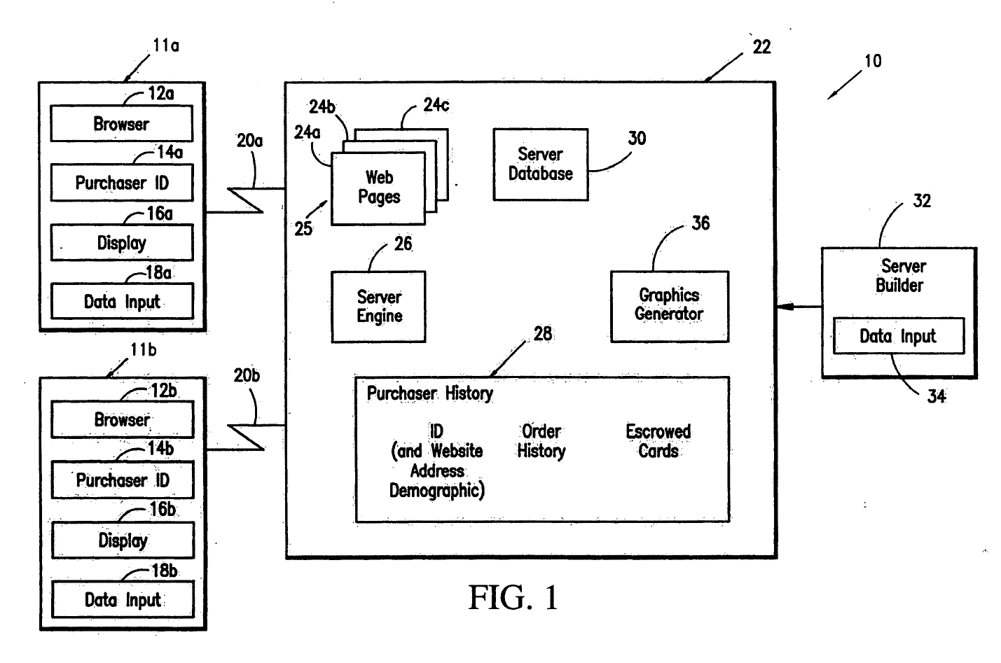

Referring now to the drawings and in particular to FIG. 1, there is shown an embodiment of an item distribution system 10 which permits a distributer or user to employ his/her terminal 11 to access a server system 22 by exchanging messages over a communication link 20, which in one example of this invention may take the form of the Internet. The terminal 11 comprises a browser 12 and its assigned item distribution identifier, which is known as a “cookie”. The item distribution identifier is stored in a file 14. Though only a pair of item terminals 11 is illustrated in FIG. 1, it will be appreciated that there would typically be two or more terminals 11a, 11b - - - 11n, which are connected to the communication links 20a and b and are capable of transmitting messages over the links 20 to the server system 22. Each of the terminals 11a, b - - - n further includes a display 16 for presenting a webpage 24 to the item distributor or user, and a data input device 18 such as a keyboard or other device well known to those skilled in the art. The webpage 24 is downloaded from the server system 22 to implement an offering for sale or exchange of an item, as will be explained below. In one embodiment of this invention, the user initiates on the browser 12 a communication session with the server system 22 by assigning and sending over the link 20 a message bearing an order for an item or collectable that is being offered for sale, along with his/her item distribution identifier to the terminal 11. From then on, the terminal 11 includes its item distribution identifier with all messages sent to the server system 22 so that the server system 22 can identify the particular terminal 11 from which the message was originally sent.

The server system 22 comprises, as shown in FIG. 1, a server engine 26, a database 25 for storing the webpages 24a, b and c, a server data base 30 and a item distribution history 28. As is well known in the art, the server engine 26 processes the item distribution messages that were transmitted from the browser 12 over the links 20 in the form of HTTP requests to access webpages 24a, b, and c identified by URLs and, in turn, transmits the requested webpages 24 to the requesting terminal 11, where the webpages 24 are presented on the display 16 of the requesting terminal 11.

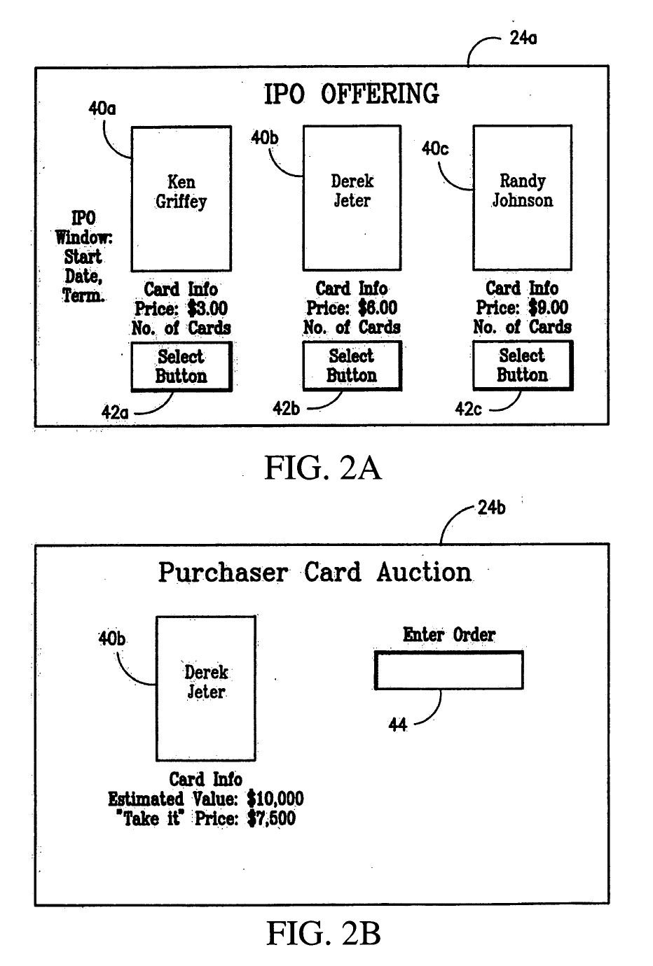

The server system 22 is front ended, as described above, in that an item distribution can access the system 22 by sending requests from the browser 12 via the communication link 20 to the server system 22, while data in the form of images of the different collectibles 40, as shown in FIGS. 2A and B, are back ended, i.e., this data is input to the server system 22 from a server builder 32. The server builder 32 includes a data input device 34, which permits the offering for a purchasing administrator to input data, e.g., the images of the collectibles, to the server system 22 and, in particular to a graphics generator 36. The generator 36 in turn creates in a manner well known in the art the webpages 24 that are stored in the webpage database 25.

Referring now to FIGS. 2A and B, there are shown web pages 24a and b, which are used in accordance with the teachings of this invention to carry out an offering for sale in the nature of an initial public offering (IPO). Such IPO's are well known methods of offering for sale an initial offering of securities. The web page 24a bears the images of three items or collectibles 40a, b and c. Though a variety of other collectibles could be offered for sale in accordance with the teachings of this invention, an illustrative embodiment of this invention is implemented by trading cards and, in particular, those trading cards that bear the likeness of athletes. For example, the collectibles 40a, b and c bear the images of well-known baseball players such as Ken Griffey, Derek Jeter and Randy Johnson, respectively.

Still referring to FIG. 2A, the webpage 24a has been particularly constructed to be used as a part an offering for sale to be carried out in accordance with the teachings of this invention. In particular, the webpage 24a bears data describing the card, e.g., information about the athlete portrayed, the price to be charged for that card, the number of cards being issued, the date when the window for entering orders will start and the length of that window. In addition, a select button 42 is embedded in the web page 24a for each of the cards 40a, 40b and 40c. When the time comes in the course of this offering for sale, the user or purchaser will click that button 42 in accordance with the card 40 that is selected, e.g., the purchaser will click on button 42b to choose the Derek Jeter card 40b.

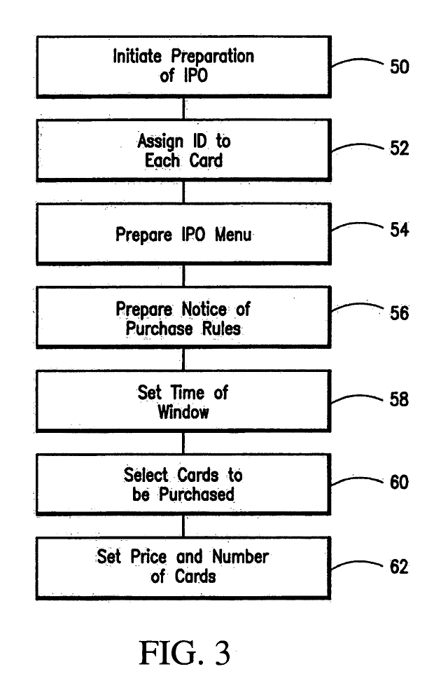

Referring now to FIG. 3, there is shown a flow chart of a program which helps the purchasing administrator to construct an Initial Player Offering for sale in accordance with the teachings of this invention. This program is stored in the server database 30 and is executed by the server engine 26. After initiating in step 50 the preparation of the Initial Player Offering for sale, step 52 prompts the administrator to enter via the data input 34 of the server builder 34 an ID number that uniquely identifies each card or collectable 40 and at least some of the important attributes of that collectable 40, e.g., the name of the athlete portrayed on the card 40, its price, its “Take It” price and the expected number of cards 40 to be offered for sale. Next in step 54, an Initial Player Offering menu appears that helps the administrator to enter selected data on and to prepare the webpages 24. In step 56, the administrator prepares via the data input 34 a webpage 24c (not shown) that sets out the rules under which the Initial Player Offering for sale will be conducted. Next in step 58, the duration of the time window during which the Initial Player Offering for sale will be conducted is entered by the administrator. Next in step 60, the administrator selects via the data input 34 the ID numbers of the collectibles 40, e.g., trading cards, to be included within the Initial Player Offering for sale. Finally, the price and number of the collectibles 40 to be included in the offering for sale are set by the purchasing administrator using the input 34 in step 62.

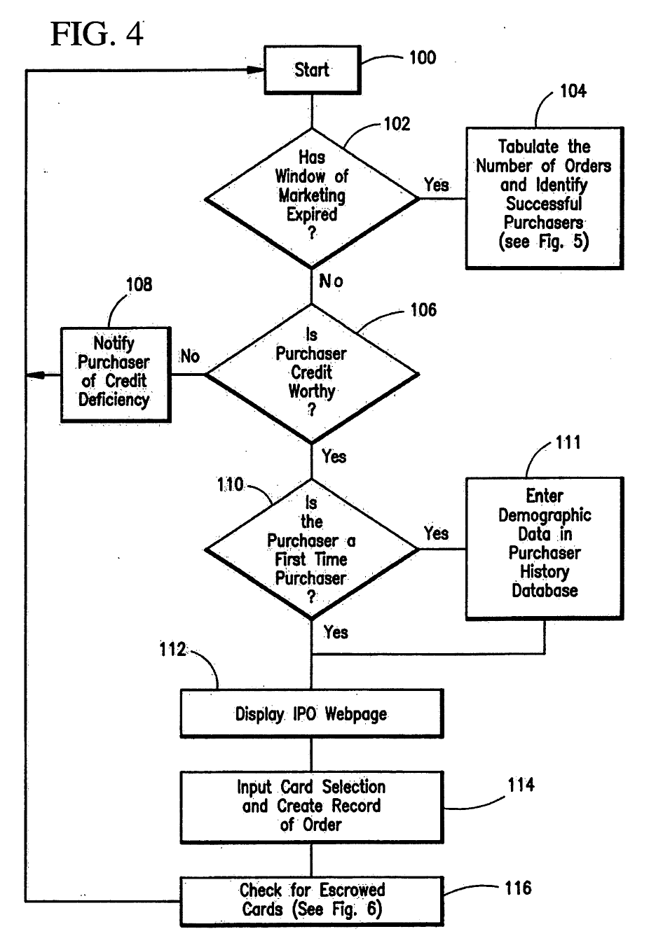

Referring now to FIG. 4, there is shown a flowchart of the programming used to carry out an Initial Player Offering for sale in accordance with this invention. After returning to start in step 100, step 102 compares in a preferred embodiment of this invention the current date with the offering for sale termination date set in step 58 and, if less, indicating that the offering for sale has not terminated, the processing moves to step 106. In a further embodiment of this invention, step 102 may terminate the offering for sale not as a function of time, but rather as a function of the number of orders received that may exceed a preset maximum number; in other words, when that number of orders have been received and recorded in the item distribution history database 28, as will be explained below, the Initial Player Offering for sale will be terminated. Then step 106 communicates with the item distribution's bank to determine the status of the user's credit card account. If credit worthy, the program continues with the steps 110, 112 and 114. If the user is not credit worthy, step 108 transmits a message via the link 20 to the originating terminal 11 to inform this user that his/her order for has been denied for credit reasons. In step 110, a user or purchaser history is built in the database 28, one user at a time. As shown in FIG. 4, an account is established for each credit worthy user. In particular, step 110 examines the user history database 28 to determine whether the present user has made a previous order and whether the demographic data for the present user is already stored in the database 28. If the demographic data for this particular user is not present indicating that this is a first time user, step 111 then enters in the user history database 28 that demographic information about the user as was entered in step 106. In a preferred embodiment of this invention, the user is requested upon first placing in step 100 an order to this server system 22 to provide certain demographic information about himself/herself, e.g., home and business addresses and telephone numbers, email address, and the account number of the credit card that the user intends to use as his/her method of payment for the cards 40 sought to be purchased in this offering for sale. The user history retained in database 28 as shown in FIG. 1 further includes data as to orders that are submitted during the offerings for sale, and further data as to the cards 40 that the user has escrowed. This data will be entered later in the processing as will be explained below.

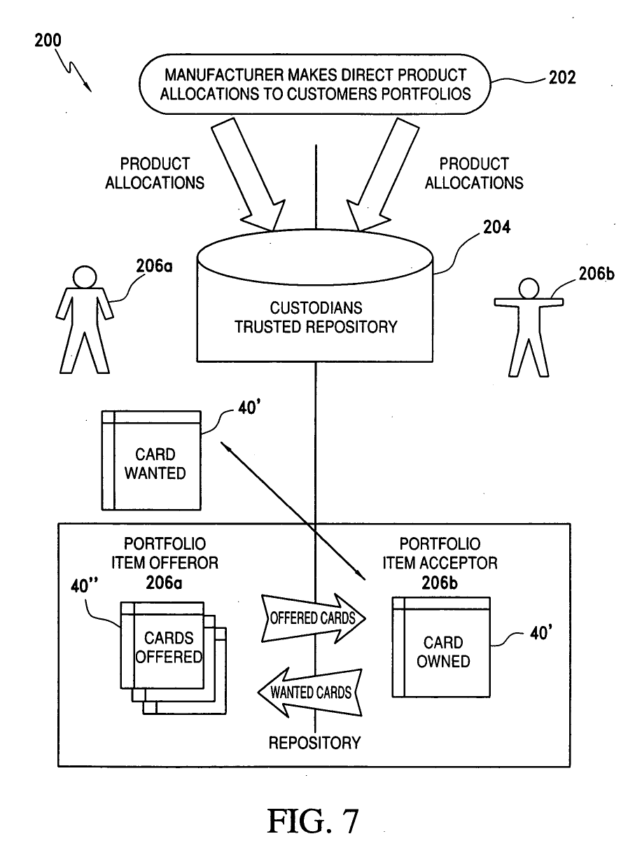

After user's account has been set up in steps 110 and 111, step 112 downloads the webpage 24a from the database 25 via the link 20 to the terminal 11 which originated the order. At this terminal 11, the downloaded webpage 24a is presented on the display 16. In step 114, the user selects one of the cards 40a, b or c to order and clicks on the button 42 corresponding to the desired card 40, e.g., the user actuates button 42b to order the Derek Jeter card 40b. Step 114 also prompts the user to enter the amount of his/her order on the data input device 18. Step 114 then enters data that identifies the selected card 42 and the amount of the order into the user's account that was established in step 110. Next step 116 checks the user history database 28 to determine whether the current user holds escrowed cards 40 and, if so, offers the primary user the opportunity to trade the escrowed cards 40 as will be explained below in greater detail with respect to FIGS. 7-11B. After step 116 has been completed, the program returns to start 100 to wait for the next order to be received by the server system 22.

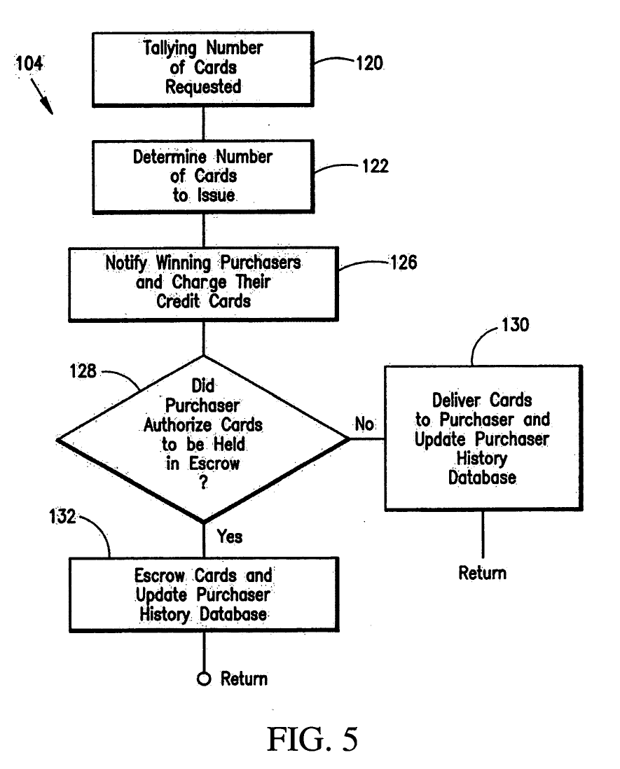

If step 102 of FIG. 4 determines that the Initial Player Offering for sale has been completed, step 120 as shown in FIG. 5 tabulates the number of the items or cards 40 upon which orders were placed and then in step 122 identifies the successful orders. In a preferred embodiment, step 122 determines whether the initial offering was oversubscribed, i.e., more cards 40 were ordered than the maximum number of cards available to the Initial Player Offering for sale. If oversubscribed, cards 40 will be allocated based on: 1) the number of the cards offered, 2) which of the item distributions placed their orders first, and 3) the prior history of the purchases of the user, i.e., the user who had purchased the most collectibles 40 in past auctions would be awarded more cards 40 in the present Initial Player Offering for sale. After the successful users are identified, notices are transmitted in step 126, typically via the Internet, to each of the successful users informing them that they had winning orders and the number of cards 40 allocated to each. In addition, step 126 causes a charge to be made against the credit card accounts of the successful users for the amount of the purchased cards 40 and further to impose charges for shipping and handling, as well as a commission for the purchasing administrator.

Further, these notices also inform the users of their options to have the awarded cards 40 sent to them or, at their choice, to escrow the purchased cards 40 with the purchasing administrator or another escrow agent. If the user elects in step 128 to take delivery of the cards 40, the cards 40 will be forwarded in step 130, for example, in a case with an authentication sticker adhered to the case. Further, step 130 may update the user history database 28 that the cards 40 have been delivered to the user. The case will be tamper-evident (not necessarily tamper proof) to provide an indication of whether or not the cards 40 had been handled and thus a possible indication of their condition. As is well known to trading card users, the value of a trading card 40 is highly dependent on its condition. If it was apparent that the case was still in tact, then there is a strong indication that the cards 40 are in “mint” condition and, therefore, can command a premium price.

If the user elects to have the cards 40 escrowed, step 132 takes the appropriate steps to place the purchased cards in escrow. In particular, step 132 updates the user history database 28 and, in particular, enters to that user's account the number of cards 40 held in escrow. Further information, such as the purchase price of the escrowed cards 40, may also be entered in the database 28. The escrowed cards 40 are stored in a benign environment to protect the condition of the cards or items. If the offering sale administrator holds the cards 40, the administrator will be able to “guarantee” the condition of the items or cards 40. The ability to guarantee the card condition would provide a significant benefit to offering for sale the items or cards 40 over the Internet. By comparison, some well-known purchasing administrators merely act a broker between a buyer and a seller, and normally will not take responsibility for the transaction, much less the condition of the purchased items. Thus after the items or cards 40 have appreciated over a period of time, the offering sale administrator can still guarantee the condition of the escrowed cards 40, and the user who now seeks to sell the appreciated cards or items 40 as well as potential new users can have reasonable confidence in the card condition, as well as the administrator's guarantee.

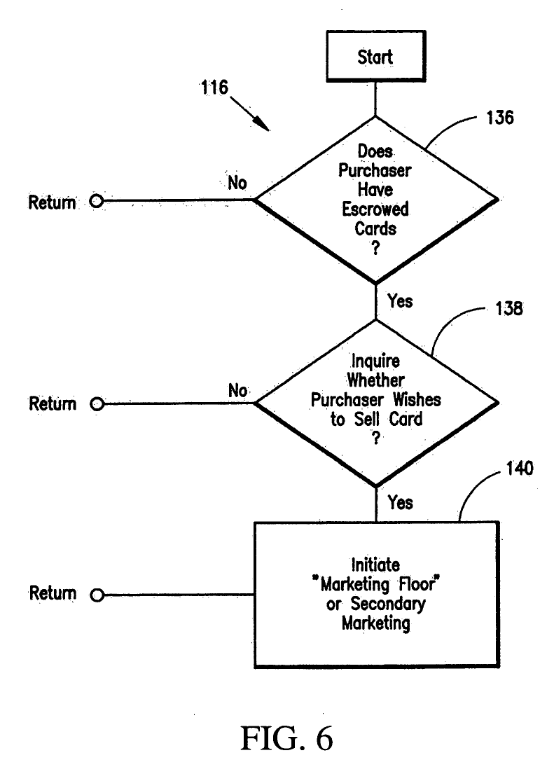

Referring now to FIG. 6, step 116 of FIG. 4 for querying a user as to whether he/she has retained items or cards 40 in escrow with the purchasing administrator is explained in greater detail. First in step 136, the program accesses the user history database 28 to determine whether the present user has previously escrowed card(s) 40. If card(s) 40 have not been escrowed, the program returns. If the user has escrowed card(s) 40, step 138 downloads a webpage 24 (not shown) to ask this user whether he/she wishes to sell any of his/her escrowed cards, whereby the user clicks on the appropriate web buttons (not shown) to answer yes or no. If no, the program makes a return at this time. If yes, step 140 initiates the offering for sale on a secondary market of the escrowed cards 40, which is explained by U.S. patent application Ser. No. 09/488,107, entitled “Method and Apparatus for Offering for Sale Collectibles on Primary and Secondary Markets.”

The escrowing feature of this invention is of particular importance to the user as he/she attempts to sell or distribute his/her items or collectibles. If the purchasing administrator is its self the manufacturer/issuer or has received the items or cards 40 directly from their manufacturer or issuer and has escrowed without delay the cards to be distributed, the purchasing administrator can guarantee the condition of these cards 40 since they have continuously been under the control of the administrator (or previously the manufacturer/issuer if partnering with the manufacturer/issuer), and the new owner is assured of the condition of the card 40 that he/she will be acquiring.

In the above, there has been described the item distribution system 10, wherein items in the form of collectibles and, in particular, cards 40 bearing the images of professional athletes are auctioned in a manner that resembles an initial placement offering (IPO). Referring now to FIG. 7, there is shown an item distribution or trading system 200, which has been particularly adapted to trade items between the users of the system 200. In such a trading system 200, the user illustratively takes the form of an item offerer 206a and an item acceptor 206b, it being understood that there is an exchange of items between the item offerer 206a and the item acceptor 206b. Further, it is contemplated that the items in an illustrative embodiment of this invention be made by a manufacturer, which directly allocates these items to the accounts of the item offerers 206a and the item acceptors 206b. As further shown in FIG. 7, the items are kept in a trusted repository 204, wherein their state is maintained in mint condition. As described above, if the items are to be subsequently traded or sold, the condition of the item is critical as to their value. Thus, it is very important that the items are maintained in the repository 204 from the time that the items are made by a manufacturer. By continuously maintaining the items in the trusted repository 204 from the time that they are made, the administrator can effectively guarantee the condition of such items to any prospective purchaser of or trader for such items.

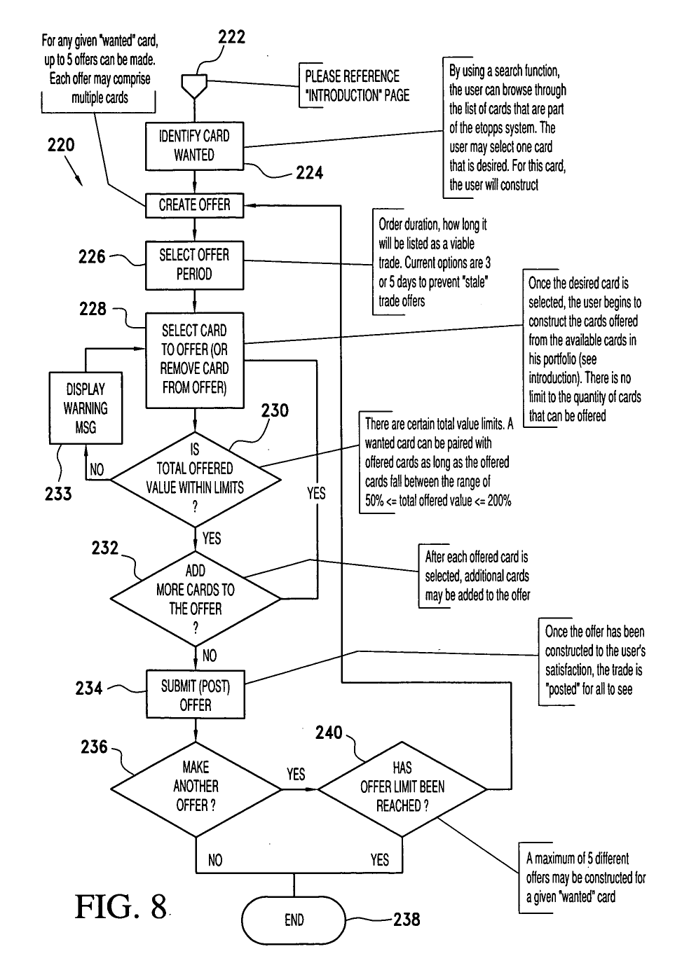

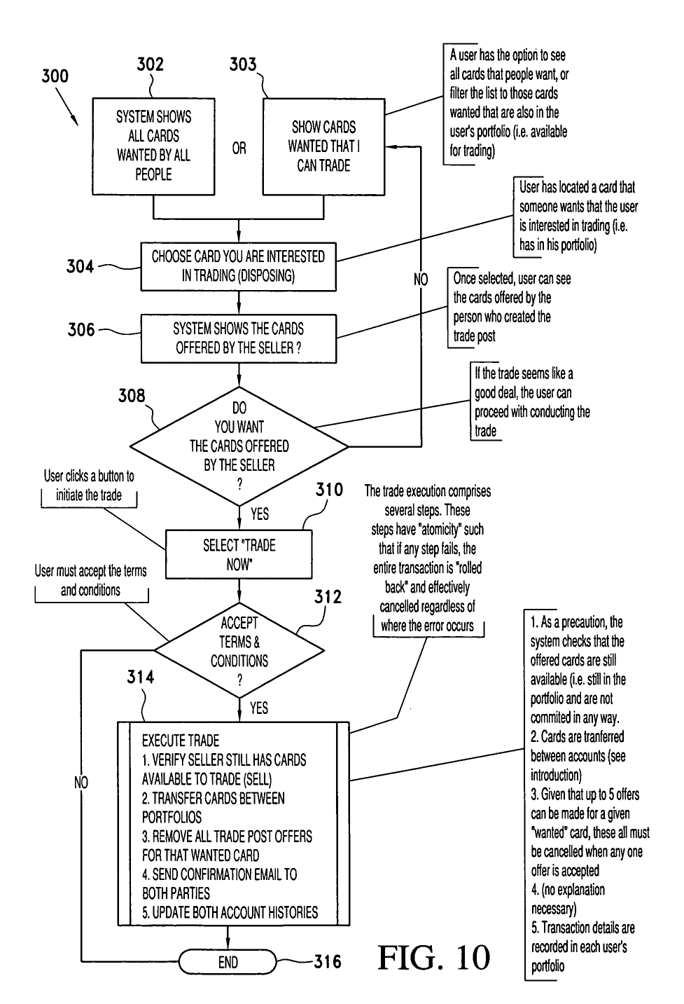

The parties to the trade have a particular role as reflected by the name of these users 206a and 206b. In particular, the item offerer 206a constructs an offer in terms of an item 40′ that the item offerer 206a would like to acquire and one or more items 40″ that the item offerer 206a owns and would be willing to trade for the wanted item 40′. As will be explained below, the process of the trade between the item offerer 206a and the item acceptor 206b is carried out by the item distribution system 10, as shown in FIG. 1, which is programmed to carry out the flow diagrams shown in FIGS. 8 and 10. As shown in FIG. 7, the offered card 40″ must be owned by item offeror 206a in his account with the Administrator and the wanted card 40′ must be owned by the item acceptor 206b in his account with the Administrator in order for the proposed trade to be completed and the cards to be transferred to the proper respective accounts.

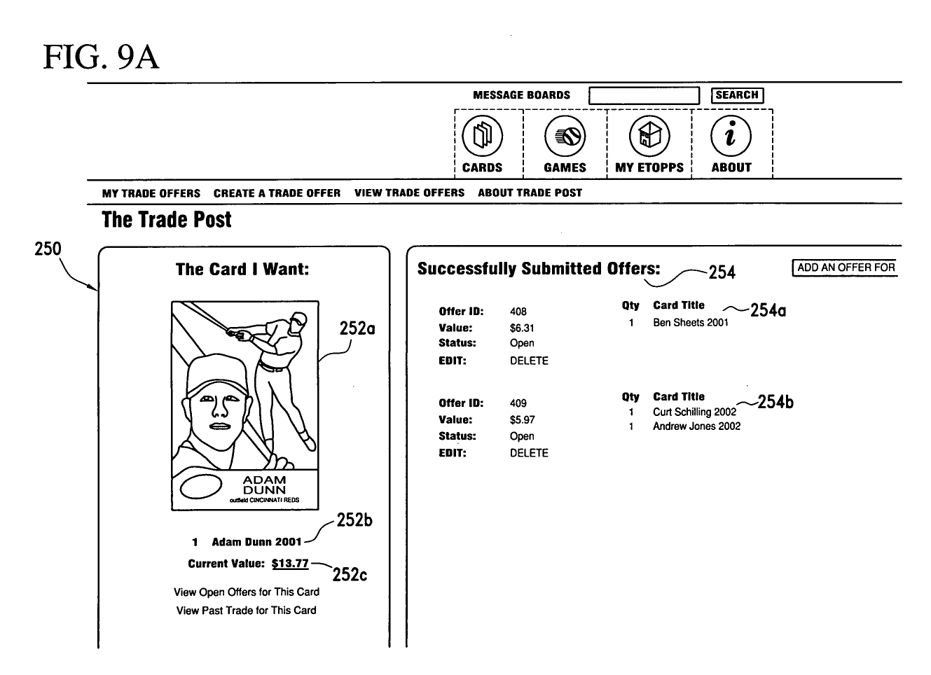

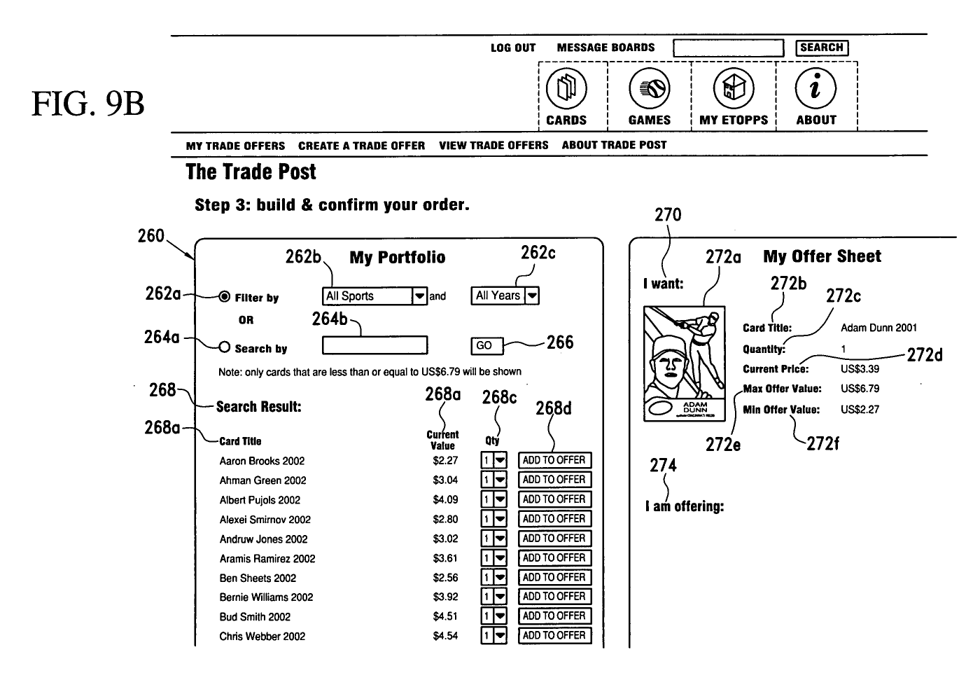

Referring now to FIG. 8, an explanation of a trade approval process 220 will now be described. After entering the program 220 at step 222, the trade approval process 220 moves to step 224, wherein a screen 250 as shown in FIG. 9A is shown on the display 16 of one of the user terminals 11. Further, the item offerer 206a can select by entering via the data input 18 of his/her user terminal 11 an image of the wanted card 40′ as shown at window 252a and the name of the athlete and the current value of the card 40′ are shown at windows 252b and 252c respectively. Further, the screen 254 also displays the previously, successfully submitted offered cards 40″. Further, the item offerer 206a can use the browser 12a of its user terminal 11 to browse through the list of all of the cards as maintained by the administrator in the repository, as shown in FIG. 1, until the item offerer 206a finds the wanted card 40′. After entering the name of the wanted card 40′, its image is displayed in a window 252a of the screen 250.

After the item offerer 206a has selected its wanted card 40′, the trade completion process 220 moves to step 226, wherein the item offerer 206a selects that period of time in which the offer constructed by the item offerer 206a may be accepted by the item acceptor 206b. In an illustrative embodiment of this invention, the selected offer period may be set at 3 or 5 days to prevent “stale” trade offers. Next in step 228, the item offerer 206a is enabled to complete the construction of its offer. In step 224, the wanted card 40′ was selected by the item offerer 206a. Now, in step 228, a screen 260 as shown in FIG. 9B will be displayed upon the display 16 of the user's terminal 11 in order to facilitate the item offerer 206a to select one or more of the offered cards 40″. The item offerer 206a is enabled in step 228 to search the offered cards 40″ in its portfolio by clicking on the button 262a to filter the search by a particular sport as shown in window 262b or for designated years as shown in a window 262c. Alternatively, the offered cards 40″ may be selected from a list displayed on a screen 268, wherein the card title 268a, the current value 268b, and the quantity 268c are displayed. To select a particular offered card 40″ to be included within his/her offer, the item offerer 206a may click on selected of the plurality of buttons 268a, whereby the corresponding offered card(s) 40″ is added to the offer. After adding a certain card 40″ to its offer, an image of that card 40″ as well as its title, the quantity of the cards 40″, the current price and maximum and minimum values are then displayed on the window 274. Further, screen 270 includes information regarding the wanted card 40′, displaying its image at window 272a and providing the card title at window 272b, the quantity of the wanted cards 40′ at window 272c, its current price at window 272d, its maximum offered value at window 272e and its minimum offer value at window 272f. When an offered card 40″ is selected as by clicking on one of the buttons 268d, an image of the selected offered card 40″ is added to that window 274 labelled “I am offering”. There is no limit to the quantity of the offered cards 40″ that the item offerer 206a may include in its offered cards 40″.

After the item offerer 206a has finished constructing its offer, an illustrative embodiment of this invention is witnessed in step 230 of FIG. 8, wherein the total value of the offered cards 40″ as selected by the item offerer 206a is compared with a maximum limit and a minimum limit. In the illustrative embodiment, the total offered value of the offered cards 40″ is compared with a first maximum limit equal to 200% of that total value and a second minimum limit of 50% of the total value. If the total offered value exceeds the maximum value or is less than the minimum value, a warning is given in step 233 to the item offerer 206a indicating that the offered value by the item offerer 206a is not realistically set with respect to the actual value of these offered cards 40″. After a warning is given in step 233, the process 220 again returns to step 228, wherein the total value of the offered cards 40″ may be adjusted by removing or adding an offered card 40″.

Next, if step 230 determines that the total value of the offered cards 40″ is within the maximum and minimum limits, the process 220 moves to step 232, wherein the item offerer 206a decides whether or not to add further offered cards 40″ to the proposed trade. If the item offerer 206a has decided to enter more offered cards 40″, the process 220 returns to step 228, wherein new offered cards 40″ may be entered or removed as explained above. On the other hand, if step 232 determines that the item offerer 206a does not want to change the present trade or offer, the process 220 moves to step 234 wherein the offer constructed by the item offerer 206a is posted and is available to the item acceptors 206b to inspect. Next, step 236 queries whether or not an item offerer 206a wishes to construct another offer of the offered cards 40″ for the card 40′. If not, the process 220 ends in step 238. On the other hand, if the item offerer 206a decides to construct another trade offer, the process 220 moves to step 240, wherein it is determined whether the item offerer 206a has constructed more than a permissible maximum number of offers. In an illustrative embodiment of this invention, the maximum limit of the number of offers that an item offerer 206A may make is set at five.

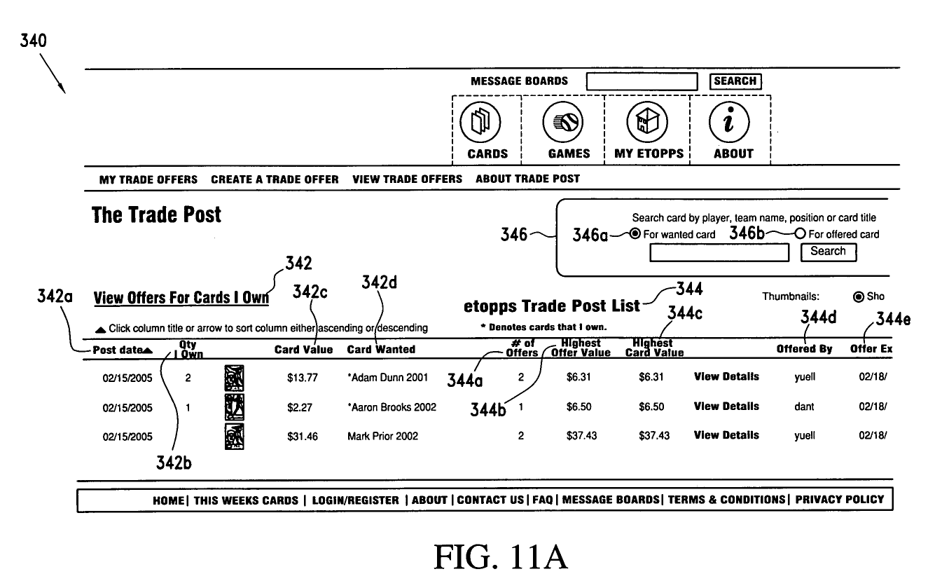

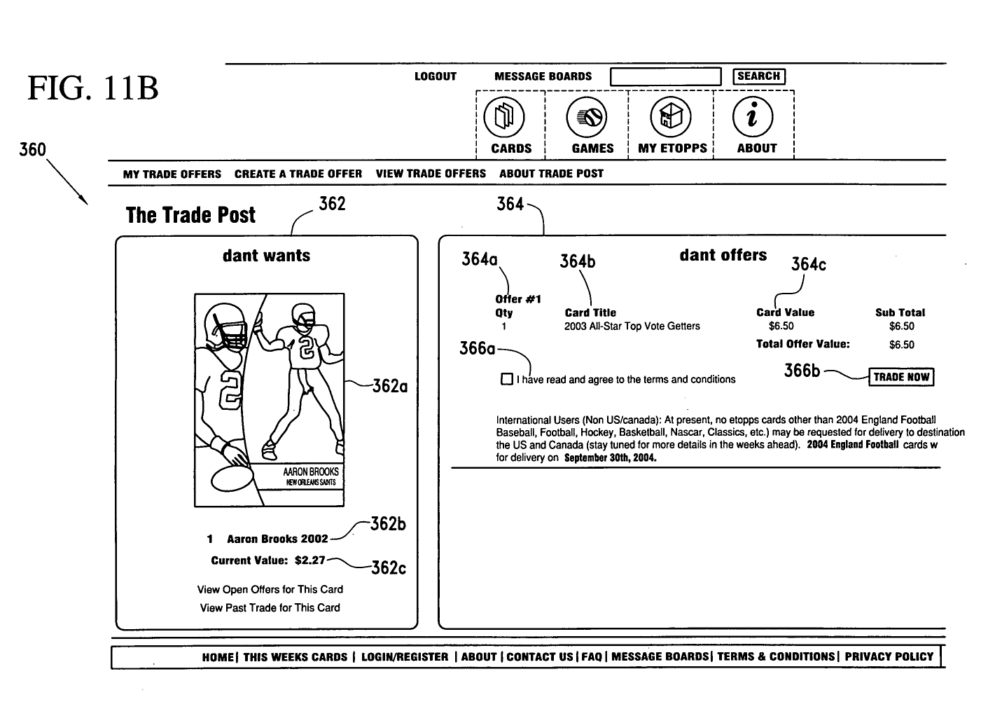

Referring now to FIG. 10, there is shown a trade completion process 300, wherein the item acceptor 206b views the posted wanted card 40′ and the offered cards 40″ to determine whether that item acceptor 206b is interested in accepting the trade, which the item offerer 206a has now constructed and offered. Initially, a screen 340 as shown in FIG. 11A is displayed to all of the potential item acceptors 206b via the display 16 of the corresponding user terminal 11 as shown in FIG. 1. The screen 340 displays a first list of wanted cards 40′ under the heading 342, which is entitled “View Offers For Cards I Own”, and a second list of all of the cards 40 or items that are stored within this distribution system 10. Thus, the item acceptor 206b has the option in step 302 to see or browse all of the cards within the system 10, which are listed under the heading 344, “E-Topps Trade Post List”. Alternatively in step 303, the item accepter 206b may filter the card list to display only those offered cards 40″ for which the item acceptor 206b has the corresponding wanted card 40′ in his/her account maintained by the administrator.

Next, the trade completion process 300 moves to step 304 where the item acceptor 206b selects a wanted card 40′ as displayed under heading 342d. Here, a screen 360 as shown in FIG. 11B is displayed to the potential item acceptors 206b. The screen 360 bears a first part in which an image of the wanted card 40′ is displayed in a window 362a along with the card's name in window 362b and value of the card in window 362c. In screen 360, “dant” indicates the name of an item offerer 206a and that his/her wanted card 40′ is the “Aaron Brooks 2002” card. Further, via step 306 and as indicated in window 364, the item offerer 206a has constructed his offer of offered cards 40″ to include a card 40″ entitled “2003 All-Star Top Vote Getters” along with the number of cards at window 364a, the title at window 364b and the value at window 364c. If the item acceptor 206b has the “Aaron Brooks 2002” wanted card 40′ and wishes to trade it for the “2003 All-Star Top Vote Getters” offered card 40″, he/she is given in step 308 a chance to decide whether or not to accept the disclosed offered cards 40″. If the item acceptor 206b wishes to make the trade, he/she will indicate his/her acceptance of the trade via step 310 by clicking on the button 366a that the item acceptor 206b in step 312 has read and accepted the terms of the transaction. He/she then clicks on the window entitled “TRADE NOW” 366b whereby the proposed trade is completed.

The process 300 then moves to step 314, wherein the five steps of the trade completion are effected. First, step 1 determines whether or not the item acceptor 206b still possesses the wanted card 40′ in its account maintained by the administrator, and the item offerer 206a still possesses the offered card(s) 40″ in its account maintained by the administrator. Such checking of the accounts of the item offerer 206a and the item acceptor 206b ensures that the offerer 206a and acceptor 206b do in fact have the required number of items and that any risk of future defaults in connection with the trade is eliminated. If so, step 2 transfers the wanted card 40′ from the account of the item acceptor 206b to the account of the item offerer 206a, and the offered cards 40″ from the account of the item offerer 206a to the account of the item acceptor 206b. As disclosed above, each of the item offerer 206a and item acceptor 206b has an account with holdings that are maintained in escrow by the administrator as shown in FIG. 1. Thereafter, all of the other offers for the wanted cards 40′ by the item offeror 206a and any offers for the offered cards 40″ previously posed by item acceptor 206b are withdrawn. In the fourth step, confirmations are sent to each of the item offerer 206a and the item acceptor 206b, thus confirming that the trade had been completed. Finally, in step 5, the account histories of both of the item offerer 206a and the item acceptor 206b as maintained in the purchaser history 28 of the server system 22 as shown in FIG. 1 are updated.

Although the present invention has been described in terms of various embodiments, it is not intended that the invention be limited to these embodiments. Modification within the spirit of the inventions will be apparent to those skilled in the art. For example, though the items of a 10 preferred embodiment of this invention are described as trading cards and, in particular, trading cards bearing data and the images of athletes, a wide range of collectibles may be so offered for sale without departing from the teachings of this invention. Further, it is contemplated that items may be traded for each other and that the items may be different from each other. For example, some items may be collectibles and other items not. Though a preferred embodiment of this invention is implemented as a web site on the Internet, this invention may be implemented on other communication systems, e.g., telephone lines and other wide area and local area networks, within the scope of this invention. It will be appreciated that though the processing of this invention has been programmed in accordance with the attached flowcharts, it would be apparent to one skilled in the computer programming arts, that other programs may be substituted for the attached flowcharts without departing from the teachings of this invention. Though the offering for sale of the primary market as taught herein may be carried out in the broadest aspects of this invention at any time, it is contemplated within the scope of this invention that the primary offering for sale may be carried out on the occurrence of special events, e.g., a pitcher throwing a no-hitter, an athlete breaking a record, the trade of an athlete from one team to another, and the drafting by a professional athletic team of a promising young player. Any of these events could trigger the issuance of a new trading card and its Initial Player Offering for sale on the primary market. Further, in order to carry out the secondary trading system described in this invention, the Initial Player Offering mechanism is not necessary as a means of initially distributing the cards or items into customers' accounts. Any primary market distribution system should suffice, provided the condition of the items/collectibles is preserved and the items/collectibles are held in accounts maintained by the administrator from the outset. The scope of the present invention is defined by the claim that follows.

I claim:

1. A method of managing the trade of at least one offered item by at least one item offeror for at least one wanted item of at least one item acceptor, said method of managing comprising the steps of:
a. establishing for the one item acceptor and the one item offeror a database for storing information identifying each item held respectively by the one item offeror and the one item acceptor;
b. facilitating the item acceptor to provide an acceptance message of trading the offered item of the item offeror for the wanted item of the item acceptor,
c. responding to the acceptance message of the item acceptor to access the database of the item acceptor to determine whether the item acceptor has the wanted item in its database and to access the database of the items offeror to determine whether the item offeror has the offered item in its database, and
d. determining whether the item acceptor and the item offer have respectively their wanted item and offered item, if so the trade continues to completion and, if not, the trade is terminated.
